(19) United States
(12) Patent Application Publication
(10) Pub. No.: US 2018/0210085 A1
(43) Pub. Date: Jul. 26, 2018

(54) Method and Device for Determining the Two-Dimensional Positional Coordinates of a Target Object

(71) Applicant: Hilti Aktiengesellschaft, Schaan (LI)

(72) Inventors: Torsten GOGOLLA, Schaan (LI); Andreas WINTER, Feldkirch (AT)

(21) Appl. No.: 15/876,804

(22) Filed: Jan. 22, 2018

Related U.S. Application Data
(63) Continuation of application No. 14/654,439, filed on Jun. 19, 2015, now abandoned.

(30) Foreign Application Priority Data
Dec. 20, 2012 (DE) 10 2012 223 929.4

(51) Int. Cl. G01S 17/46; G01C 15/00; G01S 7/491

(52) U.S. Cl. CPC G01S 17/46; G01C 15/002; G01S 7/4913

(57) ABSTRACT

A method and device for determining positional coordinates of a target object is disclosed. The method includes positioning a target on the target object, transmitting a laser beam at the target, and reflecting the laser beam off of the target. The method further includes taking an image of the target by a camera with the reflected laser beam as a light reflex in the image, where a viewing direction of the camera is inclined at an elevation angle to the measurement plane, and determining a focus of the light reflex in the image. Additionally, the method includes calculating a first distance and a second distance from a focal length of the camera, the elevation angle, and a first image coordinate and a second image coordinate of the focus of the light reflex. The positional coordinates of the target object are calculated from the first distance and the second distance.

This application is a continuation of U.S. application Ser. No. 14/654,439, filed Jun. 19, 2015, which claims the priority of International Application No. PCT/EP2013/077013, filed Dec. 18, 2013, and German Patent Document No. 10 2012 223 929.4, filed Dec. 20, 2012, the disclosures of which are expressly incorporated by reference herein.

### BACKGROUND AND SUMMARY OF THE INVENTION

The present invention relates to a method for determining the two-dimensional positional coordinates of a target object and a device for determining the two-dimensional positional coordinates of a target object.

A method and a device for determining the two-dimensional positional coordinates of a target object are known from EP 0 481 278 A1. The device comprises a laser distance measuring means, a camera means, a reference means and a control means. The laser distance measuring means has a transmission element that emits a laser beam, and a receiver that receives a laser beam at least partially reflected on the target object as a reception beam. The reference means has a first and second axis arranged perpendicular to each other and spanning an internal coordinate system; a third axis of the coordinate system runs perpendicular to the first and second axis through the intersection of the axes. The device also includes an angle measuring means for determining an azimuth angle. The target object is sighted precisely through the camera means while the target axis of the laser distance measuring means and the sighting axis of the camera means are aligned to the target object. The laser distance measurement is performed by the laser distance measuring means and the azimuth angle is determined by the angle measuring means. The two-dimensional spatial coordinates are calculated from the distance value and the azimuth angle.

The known device for determining the positional coordinates of a target object has the disadvantage that at least one angle measuring means is needed, which increases the complexity and cost of the apparatus for determining the positional coordinates. In addition, the laser beam for laser distance measurement and angle measurement must be precisely aligned to the target object.

The object of the present invention is to develop a method for determining the two-dimensional positional coordinates of a target object that is suitable for interior use and determines the positional coordinates with little effort for the operator. In addition, a suitable device for the invention's method is to be developed for determining the two-dimensional locational coordinates of a target object.

This object is achieved in the aforementioned method for determining the two-dimensional positional coordinates of a target object and in the aforementioned device for determining two-dimensional positional coordinates of a target object.

According to the invention, the method for determining the positional coordinates of a target object in a measurement plane in two dimensions comprises the steps of:
a target means with a reflector element is positioned on the target object,
a laser beam is emitted by a transmission element of a laser means along a propagation direction substantially parallel to the measurement plane to the target means,
at least a part of the laser beam is partly reflected at the reflector element,
an image of the target means with the at least partially reflected laser beam as light reflex is received by a camera means, wherein the viewing direction of the camera means is inclined at an elevation angle to the measurement plane,
a focus of the light reflex is determined in the image of the target means,
a first and second distance are calculated from a focal length of the camera means, the elevation angle and a first and second image coordinate of the focus of the light reflex in the coordinate system of the camera means, and
the positional coordinates of the target object are calculated from the first and the second distance.

Determining the positional coordinates of a target object with the help of a light reflex in an image of a camera means has the advantage that only a laser means is necessary in addition to the camera means. Because no angle measuring means is necessary, an inexpensive device can be realized. The operator can determine the positional coordinates of the target object at low cost.

Preferably, a sequence of images of the target means is taken with the camera means. The laser beam that is aimed at the target means can be designed as an expanded laser beam with an aperture angle greater than 80°, a moving laser beam, or a moving laser beam with an aperture angle smaller than 10°. With an expanded, non-moving laser beam, the laser beam is at least partly reflected on the reflector element of the target means and produces a light reflex in the image of the camera means. If the camera means takes a sequence of images of the target means, the light reflex is visible as long as the laser beam is being emitted. With a moving laser beam, the camera means takes both images of the target means with light reflex and images without light reflex.

In a first variant of the method, from the sequence of the images taken with the camera means the image with the strongest light reflex is determined as the image of the target means with the light reflex. The first variant is suitable mainly for moving laser beams in which there are both images with light reflex and images without light reflex present in the sequence of the images taken with the camera means. The image with the strongest light reflex can be determined with the help of known image processing techniques.

In a second variant of the method, the image of the target means with the light reflex is determined by averaging over several images from the sequence of the images taken with the camera means. The second variant is suitable mainly for non-moving laser beams in which the light reflex in the images is visible as long as the laser beam is being emitted. The averaging over several images with a light reflex can be done with the help of known image processing techniques.

In a preferred embodiment of the method, the taking of the images of the target means with the camera means and the emitting of the laser beam by the laser means are controlled simultaneously from a control means.

To perform the invention's method, in particular for determining the two-dimensional positional coordinates of a target object in a measurement plane, the invention's device comprises:
a target means with a reflector element that determines the positional coordinates of the target object,
a laser means with a transmission element that emits a laser beam along a propagation direction substantially parallel to the measurement plane, and a control element,
a camera means with a reception means and a control element, with a viewing direction of the camera means inclined at an elevation angle to the measurement level,
a reference means with a first axis and a second axis, with the first and second axes arranged perpendicular to each other and intersecting in an intersection point, and
a control means with a control element for controlling the laser means and the camera means, and an evaluation element for calculating the positional coordinates of the target object.

The invention's device for determining the two-dimensional positional coordinates of a target object makes it possible to determine the positional coordinates of a target object without angle measuring means. An inexpensive device can be realized by the fact that no angle measuring means is necessary. The operator can determine the positional coordinates of the target object at low cost.

In a preferred embodiment, the reflector element is designed as a rotationally symmetrical body or as a section of a rotationally symmetrical body. For two-dimensional measurements, circular cylinders or circular cylinder sections are suitable as a reflector element. A rotationally symmetrical body has the advantage that the distance from the surface to the central point is identical from all directions. The positional coordinates of the target object lie on the cylinder axis of the circular cylinder. The radius of the circular cylinder is stored in the control means or entered in the control means by the operator. The radius of the target means is taken into consideration in calculating the positional coordinates.

In a first variant, the laser means has a beam shaping optical system that expands the laser beam in a direction parallel to the measurement level with an aperture angle greater than 80°. The beam shaping optical system particularly preferably collimates or focuses the laser beam in a direction perpendicular to the measurement plane. This beam shaping optical system has the advantage that the laser beam's available power is used optimally. In determining two-dimensional positional coordinates in the measurement plane, no expansion of the laser beam is necessary in the direction perpendicular to the measurement plane. The limited power of the laser beam is distributed in the measurement plane by the beam shaping optics. Expanding the laser beam by a beam shaping optical system offers the possibility of using a stationary laser means.

The term “beam shaping optical system” includes all beam shaping optical elements that expand, collimate or focus a laser beam. The beam shaping optical system can consist of an optical element into which one or more optical functions are integrated or several optical elements are arranged in succession. Cylinder lenses, cone mirrors and similar optical elements are suitable as beam shaping optical systems for expanding a laser beam.

In a second variant, the laser device has a motor unit with the motor unit moving the laser beam in a rotation axis perpendicular to the measurement plane. The rotation of the laser beam is useful if the power density of the laser beam after the expansion is too low to obtain a visible light reflex for the evaluation in the image of the camera means. The rotation of the laser beam around the rotation axis perpendicular to the measurement plane can be performed as a rotating, scanning or tracking movement. In the rotating movement the laser beam is rotated continuously around the rotation axis; in the scanning movement it is moved periodically back and forth around the rotation axis; in the tracking movement the laser beam follows the target means. The motor unit of the second variant can be combined with a beam shaping optical system that collimates or focuses the laser beam.

In a third variant, the laser means has a beam shaping optical system and a motor unit with the beam shaping optical system expanding the laser beam in a direction parallel to the measurement plane with an aperture angle of up to 10° and the motor unit moving the laser beam around an axis of rotation perpendicular to the measurement plane. The expansion of the laser beam and the rotation around a rotation axis can be combined. The laser beam is expanded by a beam shaping optical system up to 10° and the expanded laser beam is moved by a motor unit around an axis of rotation. The combination of the beam expansion and rotation enables detection of a reception beam with a sufficiently strong power density for the evaluation of the light reflex. The rotation of the laser beam can be performed as a rotating, scanning or tracking movement.

In a first preferred embodiment, the target means of the invention's device is attached to a hand-held power tool. The current positional coordinates of the power tool can be determined with the invention's device while working with the hand-held power tool.

Embodiments of the invention are described below based on the drawings. These do not necessarily represent embodiments to scale; instead, where useful for the explanation the drawings are presented in a schematic and/or slightly distorted form. Reference is made to the relevant prior art regarding additions to the teachings directly recognizable from the drawings. It must be noted that numerous modifications and changes to the shape and detail of an embodiment can be made without deviating from the general idea of the invention. The invention's features disclosed in the description, drawings and claims can be essential for the development of the invention both individually and in any combination. Furthermore, the scope of the invention embraces all combinations of at least two of the features disclosed in the description, drawings and/or claims. The general idea of the invention is not limited to the exact form or detail of the preferred embodiment shown and described below or limited to a subject that would be restricted compared to the one claimed in the claims. For given dimension ranges, values lying within the specified limits can also be disclosed as limit values and arbitrarily used and claimed. For simplicity, the same reference numbers are used below for identical or similar parts or parts with identical or similar function.

### BRIEF DESCRIPTION OF THE DRAWINGS

FIG. 1 illustrates a device according to the invention for determining the two-dimensional positional coordinates of a target object in a measurement plane with a target means, a laser means, a camera means, a reference means, and a control means;

FIG. 2 illustrates the device of FIG. 1 with the laser means, camera means, and control means in the form of a block diagram; and

FIG. 3 illustrates an image of the target means taken with the camera means with a reflected laser beam as light reflex that is evaluated to determine the positional coordinates of the target object.

### DETAILED DESCRIPTION OF THE DRAWINGS

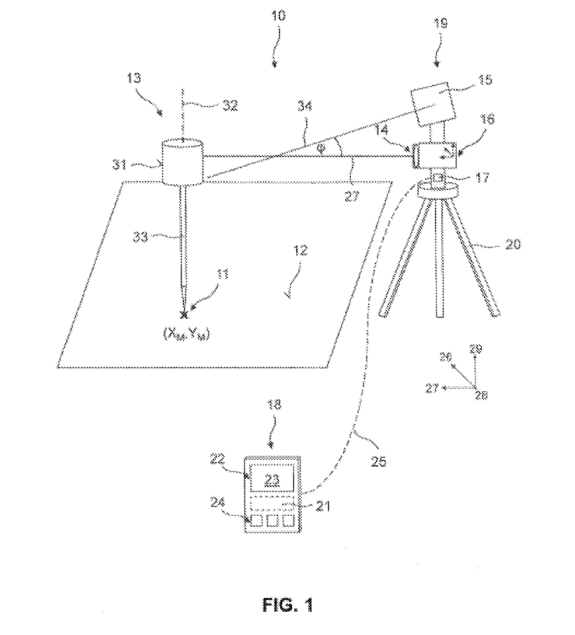

FIG. 1 shows a first device 10 according to the invention for determining the positional coordinates X_{M}, Y_{M} of a target object 11 in a measurement area 12. The measurement area 12 is formed as a measuring plane and the positional coordinates X_{M}, Y_{M} of the target object 11 are two-dimensional.

The device 10 comprises a target means 13, a laser means 14, a camera means 15, a reference means 16, a control means 17, and a hand part 18. The laser means 14, camera means 15, reference means 16 and control means 17 are integrated into a meter 19, which in the embodiment shown in FIG. 1 is attached to a device stand 20. The hand part 18 has a control element 21, a display means 22 with a display 23 and an operating means 24. As an alternative to the arrangement in the meter 19, the control means 17 can be arranged in the hand part 18. The meter 19 and the hand part 18 are connected with each other through a wireless communication link 25. As an alternative to the separation of target means 13 and hand part 18, the target means can be integrated into the hand part.

The reference means 16 comprises a first and a second axis 26, 27 which are arranged perpendicular to each other and intersect at an intersection point 28. The first and second axes 26, 27 span an internal coordinate system of the meter 19. A third axis 29 runs perpendicular to the first and second axes 26, 27 through the intersection point 28 of the two axes 26, 27. A plane spanned by the first axis 26 and second axis 27 runs parallel to the measurement plane 12 and the propagation direction of the laser means 14 runs parallel to the second axis 27. If the positional coordinates of the target object 11 are to be determined in an external coordinate system that deviates from the internal coordinate system 26, 27 of the meter 19, the coordinate systems are superimposed or the displacement and/or rotation between the external coordinate system and the internal coordinate system of the meter 19 is determined and entered manually on the meter 19 or automatically communicated to the control means 17.

The position of the target object 11 in the measurement plane 12 is marked with the help of the target means 13. The target means 13 has a reflector element 31 for reflecting a laser beam of the laser means 14. In the embodiment shown in FIG. 1, the reflector element 31 is designed as a circular cylinder and the positional coordinates of the target object 11 lie on the cylinder axis 32 of the reflector element 31. For the invention's device 10, it is important that the positional coordinates of the target object 11 arranged in the middle have the same distance from each point on the surface. The radius R of the circular cylinder 31 is stored in the control means 17 or entered by the operator in the control means 17. The reflector element 31 can be fastened on a measuring stick 33 and positioned by the operator at the target object 11. To orient the cylindrical axis 32 of the reflector element 31 perpendicular to the measurement plane 12, a leveling means, for example in the form of a spirit level or another gradient sensor, can be integrated into the measuring stick 33. As an alternative to the measuring stick 33, the target means 13 can be fastened to a wall or ceiling, placed on the floor or, for example, fastened on a vehicle or a power tool.

The laser means 14 emits a laser beam that is aimed at the target means 13. The propagation direction of the laser beam of the laser means 14 runs parallel to the second axis 27 and parallel to the measurement plane 12. To be able to determine the positional coordinates X_{M}, Y_{M} of the target object 11 through a laser beam reflected on the target means 13, a viewing direction 34 of the camera means 15 must be inclined at an elevation angle φ to the measurement plane 12. The coordinate system of the camera means 15 is rotated by the elevation angle φ relative to the internal coordinate system 26, 27 of the meter 19 and displaced by a distance. The camera means 15 can be designed rotatable around an axis of rotation or a rotation point. The viewing direction 34 of the camera means 15 can be oriented to the middle of the measuring range through the rotatability of the camera means 15.

The coordinate origin of the coordinate system of the camera means 15 can also be displaced with respect to the coordinate origin of the internal coordinate system 26, 27 of the meter 19. The rotation of the coordinate system of the camera means 15 with respect to the elevation angle relative to the internal coordinate system is necessary for the determination of the positional coordinates, whereas the displacement and a rotation with respect to an azimuth angle is not. If there is a displacement and a rotation with respect to the azimuth angle, these amounts must be known and additionally considered for determining the positional coordinates in the internal coordinate system of the meter 19.

Besides determining positional coordinates of an existing target object, the device 10 can also be used for finding positional coordinates. For this purpose, the user guides a reflector element equipped with a measurement tip or the like, which can also be integrated into the hand part, over a measurement area and searches for predetermined positional coordinates. The positional coordinates can be manually entered in the hand part or communicated through a communication link from another apparatus to the device.

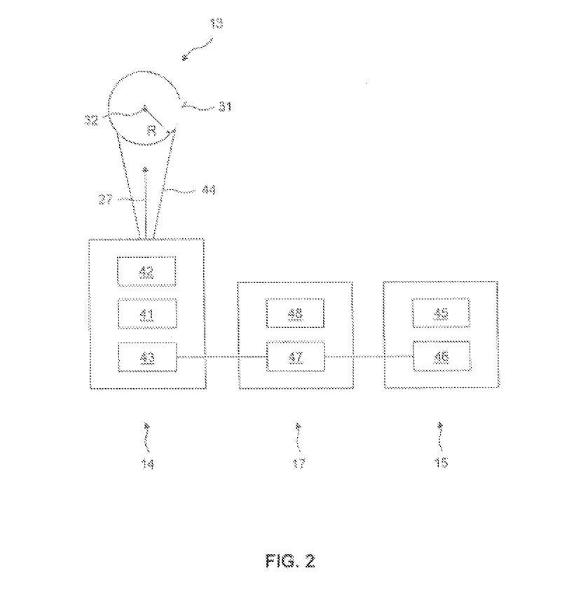

FIG. 2 shows the essential components of the meter 19 and its interaction in determining the positional coordinates of the target object 11 in the form of a block diagram. In the meter 19 are the laser means 14, camera means 15 and control means 17.

The laser means 14 comprises a transmission element 41 designed as a laser diode, a beam shaping optical system 42 and a control element 43. The laser diode 41 emits a laser beam 44 that is aimed at the target means 13. The beam shaping optical system 42 can be designed as an individual optical element or a system of multiple optical elements. To be able to determine the positional coordinates of moving target objects, in the invention's device 10 it is necessary that the laser beam 44 measure a larger angle area. This can be achieved by an expansion of the laser beam 44 in the measurement plane 12 or a rotation of the laser beam 44 around a rotation axis perpendicular to the measurement plane 12. FIG. 2 shows a laser distance measuring means 14 in which the laser beam 44 is expanded by means of a suitable beam forming optical system 42. Cylinder lenses and optical cones are suitable among other things as beam shaping optical systems 42 for the expansion.

The camera means 15 is designed, for example, as a CCD camera and comprises a reception means 45 and a control element 46 for controlling the camera means 15 and evaluating the pictures taken. The control means 17 controls the invention's method for determining the positional coordinates of the target object 11 by means of the laser means 14 and the camera means 15. The control means 17 comprises a control element 47 for controlling the laser means 14 and the camera means 15, and an evaluation element 48 for calculating the positional coordinates X_{M}, Y_{M} of the target object 11.

The operator starts the determination of the positional coordinates through a start command on the hand part 18. The start command is converted by the control element 48 of the control means 17 into a first control command to the laser means 14 and a second control command to the camera means 15. Based on the first control command, the transmission element 41 of the laser means 14 emits the laser beam 44, which strikes the reflector element 31 and is partly reflected on the reflector element 31. Based on the second control command, the camera means 15 takes a series of images of the target means 13. The laser beam 46 partly reflected on the reflector element 31 is visible in at least one image of the target means 13 as light reflex. With the help of known image processing techniques the control element 46 of the camera means 15 determines, for example, the image of the target means 13 that has the strongest light reflex. As an alternative to the image with the strongest light reflex, multiple images in which a light reflex is visible can be averaged.

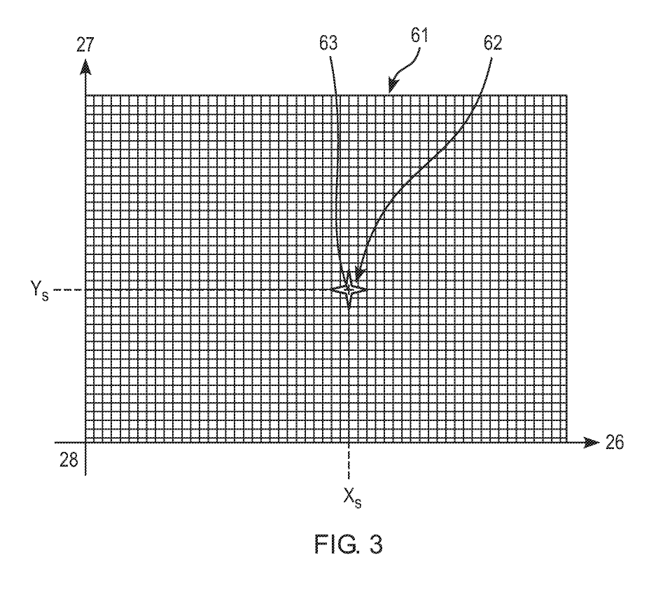

FIG. 3 shows an image 61 of the target means 13 with a light reflex 62 that is evaluated for determination of the positional coordinates X_{M}, Y_{M} of the target object 11. The image 61 consists of an array of pixels, arranged in rows and columns, with the number of pixels determined by the resolution of the camera means 15.

In image 61 of target means 13, known image processing techniques are used by control element 46 of camera means 15 to determine a focus 63 of the light reflex 62. In the coordinate system of the camera means 15, the focus 63 has a first image coordinate X_{S} and a second image coordinate Y_{S}. From the image coordinates X_{S}, Y_{S} of the focus 63 of light reflex 62 in the coordinate system of the camera means 15, a first distance d₁ and a second distance d₂ are calculated with a focal length f of the camera means 15 and rotation and possible displacement of the coordinate system of camera means 15 to the internal coordinate system 26, 27 of meter 19. The positional coordinates X_{M}, X_{Y} of the target object 11 are then calculated from the first and second distances d₁, d₂.

1. A method for determining positional coordinates of a target object in a measurement plane in two dimensions, comprising the steps of:
positioning a target with a reflector element on the target object;
transmitting a laser beam by a transmission element of a laser along a propagation direction substantially parallel to the measurement plane at the target;
reflecting at least a part of the laser beam off of the reflector element as a reflected laser beam;
taking an image of the target by a camera with the reflected laser beam as a light reflex in the image, wherein a viewing direction of the camera is inclined at an elevation angle to the measurement plane;
determining a focus of the light reflex in the image;
calculating a first distance and a second distance from a focal length of the camera, the elevation angle, and a first image coordinate and a second image coordinate of the focus of the light reflex; and
calculating the positional coordinates of the target object from the first distance and the second distance.

2. The method according to claim 1, wherein a sequence of images of the target are taken by the camera.

3. The method according to claim 2, wherein an image with a strongest light reflex in the sequence of images is used to determine the focus of the light reflex.

4. The method according to claim 2, wherein the focus of the light reflex is determined by averaging the sequence of images.

5. The method according to claim 1, wherein the steps of taking and transmitting are started simultaneously by a control device.

6. A device for determining positional coordinates of a target object in a measurement plane in two dimensions for performing a method according to claim 1, comprising:
a target with a reflector element positioned on the target object;
a laser with a transmission element that transmits a laser beam propagating along a propagation direction substantially parallel to the measurement plane;
a camera with a receiver and a control element, wherein a viewing direction of the camera is inclined at an elevation angle to the measurement plane;
a reference device with a first axis and a second axis, wherein the first axis and the second axis are arranged perpendicular to each other and intersect in an intersection point; and
a control device with a control element for controlling the laser and the camera, and an evaluation element for calculating the positional coordinates of the target object.

7. The device according to claim 6, wherein the reflector element is a rotationally symmetrical body or a section of a rotationally symmetrical body.

8. The device according to claim 6, wherein the laser has a beam shaping optical system that expands the laser beam in a direction substantially parallel to the measurement plane with an aperture angle greater than 80°.

9. The device according to claim 8, wherein the beam shaping optical system collimates or focuses the laser beam in a direction substantially perpendicular to the measurement plane.

10. The device according to claim 6, wherein the laser has a motor unit and wherein the motor unit moves the laser beam around a rotation axis perpendicular to the measurement plane.

11. The device according to claim 6, wherein the laser has a beam shaping optical system and a motor unit, wherein the beam shaping optical system expands the laser beam in a direction substantially parallel to the measurement plane with an aperture angle up to 10°, and wherein the motor unit moves the laser beam around a rotation axis perpendicular to the measurement plane.

12. The device according to claim 6, wherein the target is attached to a hand-held power tool.
